(19) United States
(12) Patent Application Publication
(10) Pub. No.: US 2007/0231242 A1
(43) Pub. Date: Oct. 4, 2007

(54) Process for the removal of carbon dioxide from flue gases and the conversion of the carbon dioxide to carbon monoxide

(76) Inventor: William G. Wilson, Missoula, MT (US)

Correspondence Address: Michael L. Dever, Esquire;Buchanan Ingersoll & Rooney PC, One Oxford Centre, 20th Floor, 301 Grant Street, Pittsburgh, PA, 15219, US

(21) Appl. No.: 11/729,010

(22) Filed: Mar. 28, 2007

Related U.S. Application Data
(60) Provisional application No. 60/786,280, filed on Mar. 28, 2006.

(51) Int. Cl. C01B 31/18

(52) U.S. Cl. 423/418.2

(57) ABSTRACT

A cryogenic air separation unit is used to separate carbon dioxide from a flue gas stream. The temperature and pressure of the carbon dioxide are controlled so that the separated carbon dioxide coming from the cryogenic air separation unit is in a liquid phase. The liquid phase carbon dioxide is converted to carbon monoxide by safely reacting the carbon dioxide with carbon at high temperature in a plasma arc reactor. The carbon monoxide produced by this reaction has sufficient energy potential to be used as a fuel.

### CROSS-REFERENCE TO RELATED APPLICATIONS

This application claims the benefit of provisional patent application Ser. No. 60/786,280 filed Mar. 28, 2006.

### FIELD OF THE INVENTION

This invention relates to a process for removing carbon dioxide (CO₂) from a combustion gas stream by converting the CO₂ to a liquid form and then reacting the CO₂ with carbon to form carbon monoxide (CO) and using the CO to generate the energy required to heat a reaction high enough to have it proceed satisfactorily.

### BACKGROUND OF THE INVENTION

A significant and substantial portion of the energy generation needs of the United States depends on the combustion of carbon-containing fuels. Any such combustion will inevitably produce CO₂. The effects of the production of CO₂ have been the subject of much research and there is recognition in the scientific field that man-made production of CO₂ has resulted in potentially damaging climate change. The problem with man-made CO₂ production has led to the Kyoto protocol and other measures to limit the production of CO₂. Although the United States is not a member of the Kyoto protocol, delegates representing the United States have outlined certain technological solutions which the United States is proposing to control CO₂ emissions such as burying CO₂ deep underground. The delegates did not publicly propose any technology that would recover all or any portion of the CO₂ generated by power plants or other operations of the like.

One proposed attempt to lower the concentration of CO₂ is to bury the CO₂ by injecting it deep in the ground. The cost of this proposal is high and does not produce any secondary beneficial use of the CO₂. There is a need for a process which decreases the amount of CO₂ in as energy efficient manner as possible.

### SUMMARY OF THE INVENTION

The present invention is a method for the removal of CO₂ from flue gas by means of a cryogenic air separator and the subsequent reaction of CO₂ with carbon to create CO which has a high calorific value. It has been reported that a 1000 megawatt electric utility plant creates 6 million tons of CO₂ per year. According to eia data (Number of Plants at U.S. Electric Utilities by Census Division and State, 2000), there are 2,776 electric utility plants in the United States. The average capacity of these electric utility plants is estimated to be 350 megawatts. Thus, the total megawatt output of all of these plants would have a combined CO₂ output of 5.829×10⁹ tons of CO₂ per year, which is equivalent to 5.205×10¹¹ moles of CO₂. The present process allows for further utilization of this CO₂ after it is converted to CO.

The preferred process uses a cryogenic air separation unit to separate the CO₂ from a flue gas stream. The temperature and pressure of the CO₂ are controlled according to the carbon-oxygen phase diagram of FIG. 2 so that the separated CO₂ coming from the cryogenic air separation unit is in a liquid phase. The liquid phase CO₂ is converted to carbon monoxide by safely reacting the CO₂ with carbon at high temperature in a plasma arc reactor. The CO produced by this reaction has sufficient energy potential to be used as a fuel.

### BRIEF DESCRIPTION OF THE DRAWINGS

FIG. 1 is a series of graphs showing the equilibrium constant as a function of temperature for various reactions involving carbon.

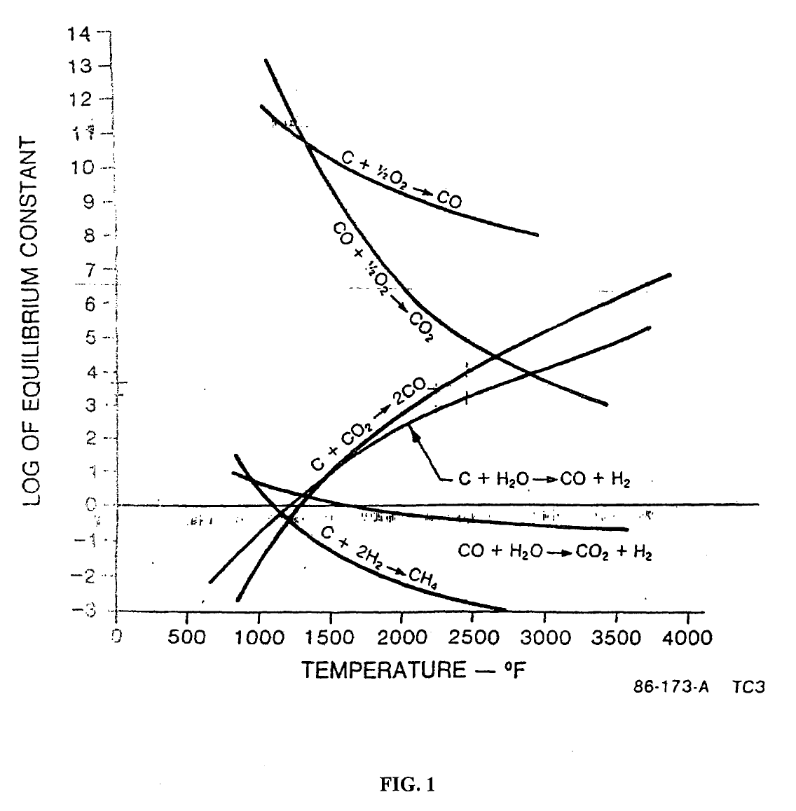

FIG. 2 is a phase diagram of the carbon oxygen system.

FIG. 3 is a graph showing the conversion of CO₂ to CO at a range of temperatures.

### DETAILED DESCRIPTION OF THE INVENTION

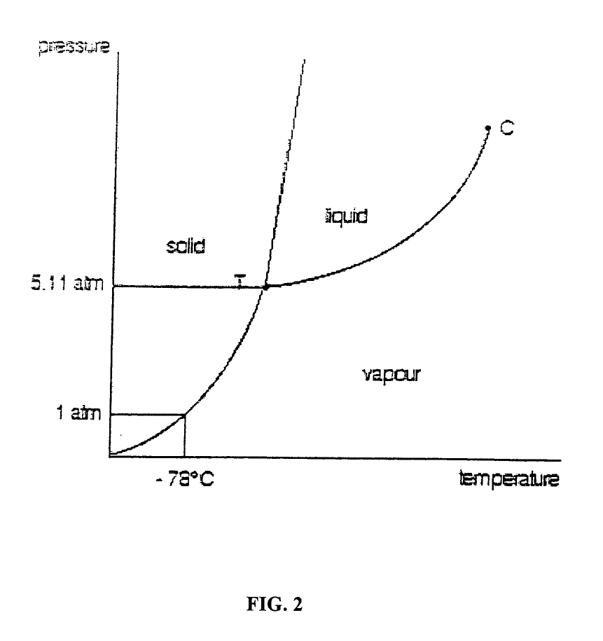

The present invention uses the process steps of separating CO₂ from a flue gas stream and converting at least a fraction of that CO₂ to CO. The CO₂ is preferably separated from the flue gas stream though a cryogenic air separation process, in which the CO₂ is converted to its liquid phase. In order to ensure that the CO₂ is in liquid phase, it is preferred that the pressure be maintained at approximately 7.0 atmospheres and the temperature maintained at approximately 78° C. The temperature and pressure needed to contain the CO₂ as a liquid can be estimated from the phase diagram of the carbon oxygen system as shown in FIG. 2.

Cryogenic air separation units are well known. Universal Industrial Gases, Inc. has installed such plants to recover the CO₂ from high-purity or low-purity feed streams generated by various sources such as ammonia, ethanol or hydrogen plants. In addition, cryogenic air separation units have also been used in the steel industry which are capable of removing 40.8 tons of O₂ in one hour.

The conversion of the separated CO₂ to CO is accomplished by introducing carbon to the liquid CO₂ in the presence of heat to enable the following reaction to proceed:

CO₂+C=2CO (1)

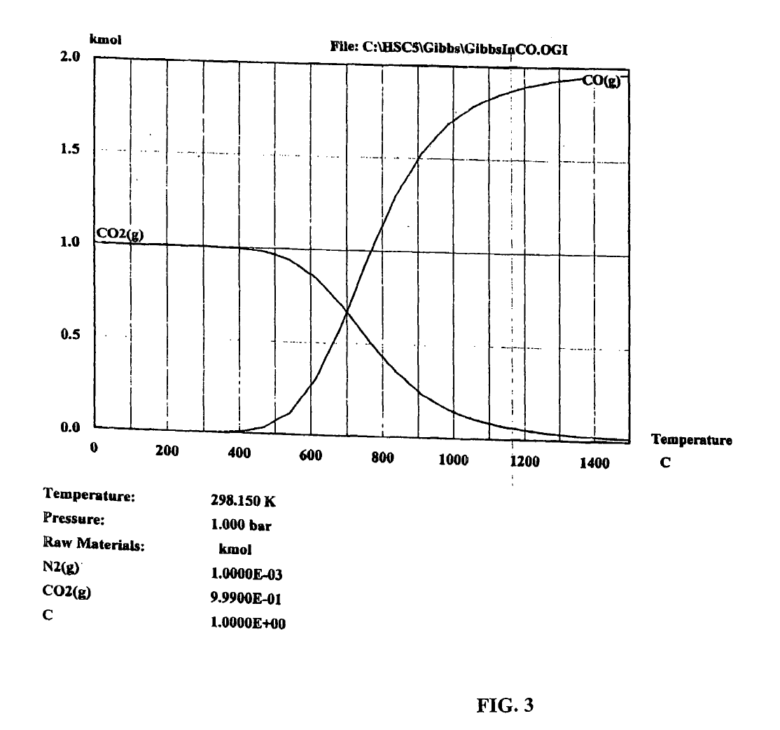

### As shown in FIG. 3, nearly all of the CO₂ is converted to CO at temperatures in excess of 1200° C.

The carbon used in this reaction can be of various forms including graphite. The liquid CO₂ and carbon are passed into a plasma furnace where the reaction will take place to form CO. The CO generated from this reaction can be used to supplant other forms of energy such as coal, hydrogen, or natural gas. Other forms of carbon injection may be utilized, but the results of other methods of adding carbon to the gas stream may not result in the same extent of creation of CO as obtained by mixing the graphite with the liquid CO₂.

Preferably, the carbon that is used in the process is graphite, which is the purest form of carbon that can be found. If the goal of the process is to remove all of the deleterious materials such as arsenic, sulfur, mercury and the like, then graphite powder should be used to prevent all such deleterious materials commonly found in coal and the like from ever entering the flue gas. If it is not required to have flue gas of such purity then other forms of carbon such as charcoal and the like may be utilized. The form of carbon used can be mixed with the liquid CO₂ and can go through the plasma arc furnace together to form CO.

The CO produced by the reaction of CO₂ and carbon provides a source of potential energy. It is possible to sequester the CO₂ to a tank that could contain substantially enough liquid CO₂ that when reacted with carbon would create enough CO that its combustion would provide enough energy to maintain the generation of heat at substantially the same level so that the reaction would function with either carbon or such hydrocarbon products as a fuel.

The CO₂ can be transferred from the storage pressure vessel to a pressure vessel immediately adjacent to burners such as are used on ships or on the boilers of electric generation plants. Any pressure vessel situated adjacent to the burners should be double walled and water filled so that the heat generated by the action of plasma arc system would be absorbed by the water flowing through the walls of the pressure vessel. This absorbed heat can be utilized in the boilers or other methods of utilizing heat to produce steam or other requirements for heat in other applications.

When the heated gases are finally admitted to the burners of the boiler or other requirement for heating they contain 32.9 kcal of energy resulting from the transformation of CO₂ to CO. When the 2 moles of CO are mixed with oxygen, the combustion results in the formation of an additional 164.367 kcals. Therefore, the sequestration of the CO₂ prior to its transformation to CO results in an additional amount of heat that when combined with the energy created by combustion of the CO amounts to a substantial increase in the heating value of the gas. In addition, the safety of the operation would be advanced in that large quantities of CO would not have to be either sequestered or transported to the burners where they would be utilized.

A thermal plasma heating system always contains some mechanism of inducing the flow of electricity through an ionized working gas. The current flow heats the gas to a very high temperature through the mechanism of resistive or Joule heating. Through electronic, atomic, and molecular collisions the gas is maintained in an ionized state and the plasma becomes self sustaining. Typical thermal plasma temperatures are in the range of 10,000° K to 30,000° K and result in heat transfers that are difficult to match by alternative processing techniques. The liquid CO₂ and carbon are passed through the plasma arc with the formation of CO according to Equation (1).

Specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples. It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

I claim:

1. A process for the removal of carbon dioxide from a flue gas stream resulting from the combustion of carbon containing fuels comprising the steps of:
(a) separating at least a portion of the carbon dioxide from the flue gas stream;
(b) maintaining said separated carbon dioxide in a liquid phase; and
(c) reacting said liquid carbon dioxide with carbon to form carbon monoxide.

2. The process of claim 1 wherein the reaction of said liquid carbon dioxide with carbon occurs at a temperature of at least approximately 1200° C.

3. The process of claim 2 where the carbon dioxide is separated from the flue gas stream in a cryogenic air separation unit.

4. The process of claim 2 wherein the reaction of said liquid carbon dioxide and said carbon occurs in a plasma heater.

5. The process of claim 2 comprising the further step of combusting said carbon monoxide produced from the reaction of said liquid carbon dioxide and said carbon to produce more energy.

6. The process of claim 1 wherein the reaction of said liquid carbon dioxide with carbon occurs at a temperature of at least approximately 1200° C.

7. The process of claim 2 where the carbon dioxide is separated from the flue gas stream in a cryogenic air separation unit.

8. The process of claim 2 wherein the reaction of said liquid carbon dioxide and said carbon occurs in a plasma heater.

9. The process of claim 2 comprising the further step of combusting said carbon monoxide produced from the reaction of said liquid carbon dioxide and said carbon to produce more energy.
